(19) United States
(12) Patent Application Publication
(10) Pub. No.: US 2024/0258657 A1
(43) Pub. Date: Aug. 1, 2024

(54) ELECTRODE FOILS FOR VEHICLE BATTERIES

(71) Applicant: GM GLOBAL TECHNOLOGY OPERATIONS LLC, Detroit, MI (US)

(72) Inventors: Hui-ping WANG, Troy, MI (US); Hui WANG, Novi, MI (US); Masound MOHAMMADPOUR, Novi, MI (US); Lu HUANG, Troy, MI (US); Jing GAO, Rochester, MI (US); Brian J. KOCH, Berkley, MI (US)

(21) Appl. No.: 18/104,389

(22) Filed: Feb. 1, 2023

(51) Int. Cl. H01M 50/536; H01M 4/04; H01M 50/105; H01M 50/533; H01M 50/54

(52) U.S. Cl. CPC H01M 50/536; H01M 4/043; H01M 4/0471; H01M 50/105; H01M 50/533; H01M 50/54; H01M 2220/20

(57) ABSTRACT

A vehicle battery includes a pouch cell configured to provide power to at least one power system of a vehicle, and multiple electrode foils stacked together at least partially within the pouch cell. Each of the multiple electrode foils includes a foil extension at an end of the electrode foil, a first group of foil extensions are connected together via a first ultrasonic weld to define a first foil extension weld portion, and a second group of foil extensions are connected together via a second ultrasonic weld to define a second foil extension weld portion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to electrode foils for vehicle batteries, and more particularly, to methods of manufacturing vehicle batteries including performing ultrasonic welding on portions of foil extensions.

### SUMMARY

A vehicle battery includes a pouch cell configured to provide power to at least one power system of a vehicle, and multiple electrode foils stacked together at least partially within the pouch cell. Each of the multiple electrode foils includes a foil extension at an end of the electrode foil, a first group of foil extensions are connected together via a first ultrasonic weld to define a first foil extension weld portion, and a second group of foil extensions are connected together via a second ultrasonic weld to define a second foil extension weld portion.

In other features, the first foil extension weld portion and the second foil extension weld portion are connected together via a third ultrasonic weld.

In other features, each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge, and the first ultrasonic weld includes an ultrasonic weld along at least one of the first side edge or the second side edge of each foil extension in the first group of foil extensions. The ultrasonic weld may be over an area of each foil extension other than the side edges.

In other features, the vehicle battery includes a lead tab configured to electrically connect the electrode foils with the at least one power system of the vehicle, wherein the first group of foil extensions and the second group of foil extensions are connected to the lead tab via a laser weld. In some implementations, the first group of foil extensions may be welded to the second group of foil extensions prior to connecting both groups of foil extensions to the lead tab.

In other features, the lead tab includes a first outer surface, and a second outer surface opposite to the first outer surface, the first foil extension weld portion is connected to the first outer surface of the lead tab via laser weld, and the second foil extension is connected to the second outer surface of the lead tab via laser weld. In various implementations, both foil extensions may be welded to a same outer surface of the lead tab.

In other features, at least a portion of the first foil extension and at least a portion of the second foil extension extend into the lead tab.

In other features, the vehicle battery includes at least one clamp on the portion of the lead tab sticking out of the battery case/pouch and in front of the portion of the tab welded to a bus bar, wherein the clamp includes at least one curve portion configured to bend the lead tab.

In other features, a surface of each foil extension defines a wrinkle pattern having multiple wave oscillations.

In other features, for each of the multiple electrode foils, a width of the foil extension of the electrode foil is less than a width of a body of the electrode foil, a curve is defined between an edge of the foil extension and an edge of the body of the electrode foil, and the curve is a C1-continuity curve.

In other features, the multiple electrode foils include at least twenty electrode foils stacked together at least partially within the pouch cell. In various implementations, there may be more or less electrode foils stacked together, and the number of stacked electrode foils may vary depending on, for example, an energy capacity of the vehicle battery.

A method of manufacturing a vehicle battery includes stacking multiple electrode foils together, each electrode foil configured to operate as a current collector of a vehicle battery, inserting a stack of the multiple electrode foils at least partially within a pouch cell. For example, electrode cells may be located fully within a pouch cell/case, with a lead tab sticking out of the pouch cell/case. Each of the multiple electrode foils includes a foil extension at an end of the electrode foil, and the method includes pressing the foil extensions to define a wrinkle pattern in each foil extension, the wrinkle pattern including multiple wave oscillations of a surface of the foil extension, performing a first ultrasonic weld on a first group of foil extensions to define a first foil extension weld portion, and performing a second ultrasonic weld on a second group of foil extensions to define a second foil extension weld portion.

In other features, the method includes performing a third ultrasonic weld to connect the first foil extension weld portion with the second foil extension weld portion.

In other features, each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge, and performing the first ultrasonic weld includes performing an ultrasonic weld along at least one of the first side edge or the second side edge of each foil extension in the first group of foil extensions. The ultrasonic weld may be over an area of each foil extension other than the side edges.

In other features, the method includes performing a laser weld to connect the first group of foil extensions and the second group of foil extensions to a lead tab, wherein the lead tab is configured to electrically connect the electrode foils with at least one power system of a vehicle.

In other features, the lead tab includes a first outer surface, and a second outer surface opposite to the first outer surface, the first foil extension weld portion is connected to the first outer surface of the lead tab via laser weld, and the second foil extension is connected to the second outer surface of the lead tab via laser weld.

A method of manufacturing a vehicle battery includes stacking multiple electrode foils together, each electrode foil configured to operate as a current collector of a vehicle battery, inserting a stack of the multiple electrode foils at least partially within a pouch cell, each of the multiple electrode foils including a foil extension at an end of the electrode foil (which may be connected to a lead tab), curling a portion of a lead tab around a curved surface of a clamp, the lead tab configured to electrically connect the electrode foils with at least one power system of a vehicle via the bus bar, laser welding the lead tab to the bus bar while the lead tab is curled around at least a portion of the clamp, and removing the clamp after laser welding the lead tab to the bus bar, to relieve tension in the foil extensions.

In other features, the method includes, prior to laser welding the lead tab to the bus bar, performing a first ultrasonic weld on a first group of foil extensions to define a first foil extension weld portion, and performing a second ultrasonic weld on a second group of foil extensions to define a second foil extension weld portion.

In other features, the method includes performing a third ultrasonic weld to connect the first foil extension weld portion with the second foil extension weld portion.

In other features, each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge, and performing the first ultrasonic weld includes performing an ultrasonic weld along at least one of the first side edge or the second side edge of each foil extension in the first group of foil extensions.

In other features, the method includes, prior to performing the first ultrasonic weld and the second ultrasonic weld, pressing the foil extensions to define a wrinkle pattern in each foil extension, the wrinkle pattern including multiple wave oscillations of a surface of the foil extension.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of multiple electrode foils including foil extensions separated into groups with ultrasonic welds;

FIG. 2A is a top view of multiple electrode foils including foil extensions, cut out of an example large electrode sheet, where the electrode foils may be stacked to form a battery cell;

FIG. 2B is a top view of the large electrode sheet cut into multiple electrode foils, with the foil extensions each having a greater width and a larger curve than the foil extensions of FIG. 2A;

FIG. 3A is a side view of an example vehicle battery pouch, and foil extensions separated into two groups;

FIG. 3B is a top view of multiple foil extensions joined together via side edge ultrasonic welds;

FIG. 3C is a top view of multiple foil extensions joined together via ultrasonic welds over an area of each foil extension;

FIG. 4 is a side view illustrating an example of two groups of ultrasonic welded foil extensions coupled to outside portions of a lead tab;

FIG. 5A is a side view illustrating an example apparatus for pressing foil extensions to generate a wrinkle pattern;

FIG. 5B is a side view illustrating an example ultrasonic welding apparatus for joining a wrinkled foil extensions using a horn and anvil;

FIG. 6A is an orthogonal view illustrating an example of lead tabs welded to bus bars;

FIGS. 6B and 6C are top views of example lead tabs of FIG. 6A curled around clamps; and

FIG. 7 is a flowchart depicting an example process for manufacturing a vehicle battery including performing ultrasonic welding on foil extensions.

In the drawings, reference numbers may be reused to identify similar and/or identical elements.

### DETAILED DESCRIPTION

While battery cells with anode electrodes (e.g., electrode foils) and cathode electrodes are described herein in the context of EVs, the battery cells can be used in stationary applications and/or in other applications.

Some vehicle batteries are manufactured using pouch cells, which may house multiple electrode foils. For example, multiple electrodes (e.g., electrode foils) may be stacked at least partially within the pouch cell, to provide power to at least one power systems of a vehicle (such as the motor of an electric vehicle). As an example, a pouch cell may include about twenty electrode foils stacked together, about thirty electrode foils, about sixty electrode foils, etc.

In a battery structure for, e.g., powering an electric motor of an electric vehicle, a battery module may include multiple battery pouch cells, each including multiple foils that are stacked together within the pouch cell. The foils may include foil extensions that are joined together at each end of the pouch cell, for connection to, e.g., a lead tab, etc., to provide power to a power system of the vehicle.

Any suitable electrode foils may be used, such as aluminum foils, copper foils, etc. For example, the foils may include aluminum alloy foils, electrodeposited foils, rolled annealed foils, roll-clad foils, copper alloys including tin, aluminum, silver, etc. The electrode foils may have any suitable thickness, such as about 4 micrometers, a value in a range of 0.01-0.03 mm, less than 0.1 mm, etc. The electrode foils may operate as current collectors, where current from each individual electrode foil is combined at the joined foil extensions. Each electrode foil may operate as an anode, a cathode, etc.

In some cases, electrode foils inside a pouch cell may fracture during a jacking safety test (e.g., a safety test where ends of the pouch cell, or foil extensions at the ends of the pouch cell are constrained, and tension and compression cycling are implemented at the ends along with cycling up and down forces on the pouch cell).

For example, when twenty or more layers of electrode foils are welded together and under tension parallel to the center plane of multiple foil extensions, tension stresses may vary among different electrode foils. In some cases (such as a horizontal pull), tension stresses in the electrode foils may be highest at the electrode foils in the center of the stack, with lower tension stresses at foils in the periphery. A larger angle θ between a center line of the stack and a position of the foil may create a larger stress difference, and a higher stress in the center foil. In some cases (such as a road condition shaking test), a pulling direction may downward or upward and peripheral electrode foils may experience the highest tensile stress. For example, when the tension has a component vertical to the center plane of multiple foil extensions, the high-tension stresses may move from the center foil to the foils in the periphery.

In various implementations, methods of manufacturing vehicle batteries may reduce stresses on the foil extensions, even when under tension, during service of a vehicle, during the jacking safety test, etc. Some example embodiments described herein may facilitate battery electrode foils avoiding high tension during their service, and physical tests.

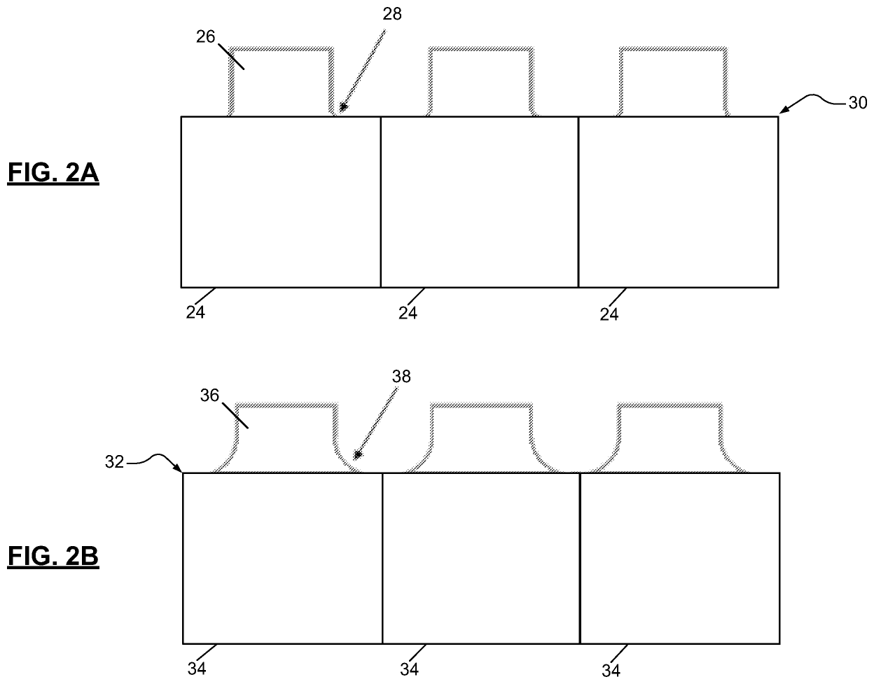

For example, foil extensions of the electrode foils may be cut to have large round corners, large curves, tapered transitions, etc., where the electrode foil extension extends out from the body of the electrode foil. An example of a larger rounded curve 38 between the foil extension 36 and the foil body 34 of the electrode foil 32 is illustrated in FIG. 2B.

This may increase the load bearing area at the portion between the foil extension 36 and the foil body 34 of the electrode foil. The transition shape may be any suitable shape, such as an arc, an elliptical shape, other curves, etc. In various implementations, the transition may have C1 continuity, to avoid stress concentration at the curve.

For example, C1 continuity may include a transition from the electrode foil body to the foil extension having a continuous slope (e.g., a shoulder between the foil body and the edge where the foil extension extends from the foil body may have a continuous slope). In various implementations, the C1 continuity may include a continuous magnitude and direction of a tangent vector throughout the curve.

In some example embodiments, the foil extensions (e.g., thin foils) may be divided into two or more groups to reduce the angle θ between a center line of each group and a position of the foil in the group to reduce stress difference. The foil extensions within a group may be pre-welded into a strong composite group using ultrasonic welding, before joining all the composite groups together (e.g., by laser welding the pre-welded groups to a lead tab, etc.). Using ultrasonic welding to pre-weld groups of foil extensions may reduce stress differentiation among the foils in the pouch, once the pre-welded groups of foil extensions are welded to a lead tab or other conductor.

In some example embodiments, the foil extensions may be divided into two or more groups, with the foil extensions in each group being welded together at edges of the foil extensions. For example, ultrasonic welding may be performed at sides (e.g., edges) of the foil extensions withing a group, to strengthen the edges before joining all the foil extensions together. This may inhibit or prevent crack initiation from the edges of the extension foils.

in various implementations, wrinkle patterns may be introduced in the foil extensions before the ultrasonic pre-welding process. For example, a press may be used to press oscillation waves into a surface of the foil extensions, a horn and an anvil may be used to generate the wrinkle patterns, etc.

This approach may increase the resistance of foils against out of plane loads and bending. Also, this approach may preserve foil extensions from extra stretches by reserving some space for possible tensions from the module assembly process.

In some example embodiments, the foil extensions (e.g., thin foils) may be divided into two or more groups, and foil extensions within each group of foil extensions may be joined together using ultrasonic welding. A lead tab may then be placed between the pre-welded groups of foil extensions, with the groups of foil extensions welded to outer surfaces of the lead tab (e.g., via laser welding, ultrasonic welding, resistance welding, etc.).

For example, a first group of foil extensions may be welded to a top side of the lead tab, and a second group of foil extensions may be welded to a bottom side of the lead tab. An example of groups of foil extensions coupled to both sides of a lead tab is illustrated in FIG. 4. This approach may reduce extra tension in the foil extensions and inhibit crack initiation. As an example, a lead tab may be, e.g., a copper sheet having a thickness of approximately 0.5 mm (which may be a single layer). The lead tab may be attached to foils on one side of the lead tab, or the lead tab may be connected between groups of foils.

In various implementations, the foil extensions may be at least partially overlapped with a lead tab prior to welding the foil extensions to the lead tab (e.g., the lead tab may cover the foil extensions prior to joining the foil extensions to the lead tab). The lead tab may be configured to electrically couple the electrode foils to power system(s) of a vehicle, such as an electric motor of an electric vehicle.

In some example embodiments, clamps may be used to pre-curl groups of foil extensions, (e.g., in a length direction). The clamps may include curved surfaces to curl, bend, etc. a lead tab, before bending the lead tab over (if desired) to mate with the bus bar. Then, laser welding (or another suitable electrode coupling technique) may be used to couple the foil extensions to the lead tab, the bus bar, etc.

The clamps may be unclamped and removed after the welding is completed. For example, the clamp may be removed (e.g., by sliding out, unclamping, uncurling, etc.), to release tension in the foil extensions. The clamp surface may have an arc shape, an S shape, etc. For example, some curls or curves (e.g., a last curve) may have opposite-direction bends with respect to the bend of the tab to the bus bar. The clamps may be inserted before bending the lead tabs, and the clamps may be pulled out after the lead tab to bus bar welding.

As described above, subdividing the foil extensions into two or more groups, and pre-welding each group of foil extensions into one composite sheet (e.g., using ultrasonic welding) before joining all of the composite sheets in both groups together, may help reduce stress differentiation among the electrode foils in the pouch. For example, a first group of the foil extensions may be joined via an ultrasonic weld to form a first foil extension weld portion, and a second group of the foil extensions may be joined via a second ultrasonic weld to form a second foil extension weld portion.

Each ultrasonic weld portion may more evenly distribute stresses among the foil extensions in the group, to reduce a likelihood of cracking, etc. The first foil extension weld portion and the second foil extension weld portion may be joined together via a third foil extension weld portion, the two foil extension weld portions may be joined to a lead tab on outside surfaces of the lead tab (e.g., via laser or ultrasonic welding) or by putting the foil extension weld portions on a top or bottom surface of the lead tab, etc.

Although two groups of foil extensions are described in the above example, in various implementations more than two groups may be used to further reduce stress differences and have more evenly distributed tensions among the foil extensions. For example, foil extensions would be divided into three different groups, four different groups, etc., with less foil extensions per group. In these examples, there may be more than two foil extension weld portions, further reducing the stress differences among individual foil extensions within each group.

The foil extensions within a group may be ultrasonically welded at ends of the foil extensions opposite to the bodies of the electrode foils, along side edges of the foil extensions, etc. For example, using ultrasonic welding to strengthen edges of the foil extensions within each group, before joining all of the composite foil extensions together from all groups, may help reduce or prevent crack initiation along the edges of the foil extensions.

In various implementations, wrinkle patterns may be introduced in the foil extensions before the ultrasonic pre-welding process. This approach may increase the resistance of foils against out of plane loads and bending. Also, this may preserve foil extensions from extra stretching, by reserving some space for possible tensions during, e.g., a battery module assembly process.

For example, a press having hills and valleys may be pressed into the foil extensions to define a wrinkle pattern, where the wrinkle pattern includes multiple wave oscillations of a surface of each foil extension. A horn and anvil machine with wavy mating surfaces may be used to add a wrinkle pattern in an ultrasonic approach.

In some example embodiments, the groups of lead tabs may be curled in a length direction using clamps having curved surfaces, before mating the lead tabs with a bus bar to be laser welded. In this example, the lead tabs may be unclamped once the welding is completed, to provide relaxation to the foil extensions and reserve room for possible extension during service.

The curls may be in arc shape, an S shape, etc., or other clamp shapes that increase a length of the portion of the foil extensions that is relaxed after welding. The last curls may have an opposite-direction bend with respect to the bend of tab to the bus bar (e.g., a bend of a foil extension to a lead tab). The clamps may be inserted before bending the tabs, and pulled out after the lead tab to bus bar welding.

For example, manufacturing of the vehicle battery may include sliding a clamp in to bend or curl lead tabs before laser welding, then removing the clamp by sliding it out (e.g., up or down the bus bar), so that there is relieved stress and tension after the clamp removed. This manufacturing approach may reduce stresses on lead tabs and electrode foils (e.g., reduced stress for internal wiring of the batteries and connections to tabs), reserve room for extension of electrode foils and lead tabs, and inhibit or prevent failure during service of the vehicle battery.

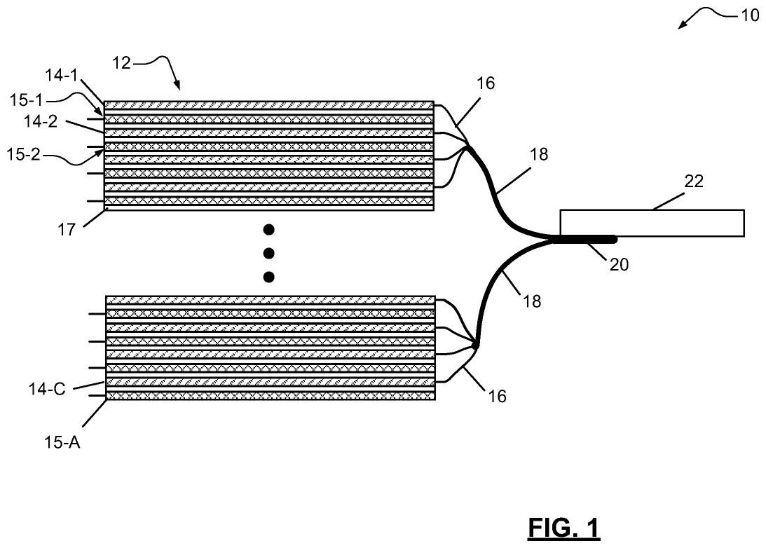

FIG. 1 is a side view of multiple electrodes (e.g., electrode foils) including foil extensions (or external foil tabs) separated into groups with ultrasonic welds. As shown in FIG. 1, a vehicle battery 10 includes a pouch cell 12 having multiple stacked electrode foils.

In particular, the pouch cell 12 includes cathode electrodes 14-1, 14-2, . . . , and 14-C (collectively or individually cathode electrodes 14), and anode electrodes 15-1, 15-2, . . . , and 15-A (collectively or individually anode electrodes 15). In some examples, the cathode electrodes are arranged in an alternating stacked arrangement with separators 17 arranged therebetween. The pouch cell 12 may include any suitable number of electrodes and separators, such as at least twenty stacked electrodes, at least thirty stacked electrodes, at least sixty stacked electrodes, etc.

The cathode electrodes 14 may include cathode coatings arranged on opposite sides of cathode current collectors. In some examples, the cathode electrode coating includes cathode active material, binder, solvent, and/or additives. In some examples, the cathode current collectors are made of aluminum foil, and have a thickness in a range from 10 to 20 μm (e.g., 16 μm).

The anode electrodes 15 may include anode coatings arranged on opposite sides of anode current collectors. In some examples, the anode electrode coating includes anode active material, binder, solvent, and/or additives. In some examples, the anode current collectors are made of copper foil, and have a thickness in a range from 7 to 20 μm (e.g., 8 or 9 μm).

Each cathode electrode 14 includes a foil extension 16 (e.g., an external electrode tab). The foil extensions 16 may extend out of the pouch cell 12, for connection with a lead tab 22 to provide power to a power system of a vehicle (such as providing power to an electric motor of an electric vehicle).

Although FIG. 1 illustrates connections for foil extensions 16 of each cathode electrode 14, it should be appreciated that each anode electrode 15 may include foil extensions, and the foil extensions of the anode electrodes 15 may be joined together on an opposite side (e.g., left side of FIG. 1), in a manner similar to the foil extensions 16 of the cathode electrodes 14 as illustrated in FIG. 1. In some example embodiments, extensions of electrode foils may be joined together on a same side (e.g., the anode electrodes 14 may be joined together on a same side of the pouch cell 12 as the joining of the cathode electrodes 15).

As shown in FIG. 1, a first group of the foil extensions 16 are joined together via an ultrasonic weld 18, and a second group of the foil extensions 16 are joined together via an ultrasonic weld 18. The first group may include foil extensions 16 from cathode electrodes 14 in, e.g., a top half of the pouch cell 12, and the second group may include foil extensions 16 from cathode electrodes 14 in, e.g., a bottom half of the pouch cell 12. Although FIG. 1 illustrates two groups of foil extensions, in various implementations the vehicle battery 10 may include more than two groups of foil extensions and more than two ultrasonic welds.

The two ultrasonic welds 18 are joined together at the weld portion 20. The weld portion 20 may be another ultrasonic weld, a laser weld, etc. For example, the lead tab 22 may cover the ultrasonic welds 18, and foil extensions 16 in the ultrasonic welds 18 may be welded to the lead tab 22 to form the weld portion 20. Groups of the foil extensions 16 may be welded to the lead tab 22 using any suitable fusion welding methods, such as laser welding, resistance welding, etc.

In various implementations, the ultrasonic welds 18 may be overlapped with at least a partial portion of the lead tab 22. As described further below with reference to FIG. 4, in other embodiments the ultrasonic welds 18 may be laser welded to outside surfaces of the lead tab 22.

Although FIG. 1 illustrates foil extensions 16 on one side of the pouch cell 12, in other embodiments each cathode electrode 14 (e.g., each electrode foil) may include foil extensions extending out both ends of the pouch cell 12. In that case, there may be groups of foil extensions joined together via corresponding ultrasonic welds on both ends of the pouch cell 12, for coupling with lead tabs on each end of the pouch cell. A lead tab may be joined with the foil extensions 16 on one side surface of the lead tab, on both opposite side surfaces of the lead tab, etc.

FIG. 2A is a top view of an example stacked arrangement of multiple electrode foils 30, which may be cut out of, e.g., a large electrode sheet. For example, a battery manufacturing process may begin with a roll of foil sheet being coated with electrode material in, e.g., a center portion of the foil sheet. The coated electrode sheet may then be laser cut into electrode foils in a desired dimension, such as the example electrode foils 30 illustrated in FIG. 2A.

Each electrode foil 30 may include a foil extension 26, which may be an area of the foil that does not include any electrode coating (such as an edge of the large electrode sheet). The electrode foils 30 may be stacked, with the foil extensions 26 being joined together (e.g., as shown and described in further examples herein). As described further below, the joined foil extensions 26 may be further joined to a lead tab. The lead tab may stick out of a battery case/pouch, after the stacked electrode foils 30 are packed in the battery case/pouch. The lead tab may then be welded to a bus bar (e.g., as shown and described in further examples herein), during assembly of a battery pack.

For example, the electrode foils 30 of FIG. 2A may be produced in a connected manner initially (e.g., a long sheet of electrode material), where the foil extensions 26 are cut out, and then individual electrode foils are separated for stacking within a pouch cell of a vehicle battery.

As shown in FIG. 2A, each electrode foil includes a foil body 24, and a foil extension 26. The foil extension 26 may be integral with the foil body 24, and extend outward from the foil body 24. The foil extension 26 may be generally rectangular, with a first end integral with the foil body 24, a second end opposite to the foil body 24, and two side edges which are, e.g., approximately perpendicular with the end of the foil body 24.

A rounded corner 28 is defined between the end of the foil body 24 and side edges of the foil extension 26. The width of the foil extension 26 is less than the width of the foil body 24. For example, a width of the foil extension 26 may be about sixty percent of a width of the foil body 24.

FIG. 2B is a top view of multiple electrode foils 32 each including a foil extension 36 having a greater width and a larger curve 38 than the foil extensions 26 of FIG. 2A. Similar to FIG. 2B, the electrode foils 32 of FIG. 2A may be produced in a connected manner initially (e.g., a long sheet of electrode material), where the foil extensions 36 are cut out, and then individual electrode foils are separated for stacking within a pouch cell of a vehicle battery.

As shown in FIG. 2B, each electrode foil 32 includes a foil body 34, and a foil extension 36. The foil extension 36 may be integral with the foil body 34, and extend outward from the foil body 34. The foil extension 36 may be generally rectangular, with a first end integral with the foil body 34, a second end opposite to the foil body 34, and two side edges which are, e.g., approximately perpendicular with the end of the foil body 34.

A curve 38 is defined between the end of the foil body 34 and side edges of the foil extension 36. The curve 38 may be larger than the rounded corner 28 of FIG. 2A, to increase the load bearing area at the transition between the edge of the foil body 34 and the edge of the foil extension 36.

For example, the curve 38 may have any suitable shape, such as an arc shape, an elliptical shape, other curve shapes, etc. In various implementations, the curve 38 may have C1-continuity, e.g., a continuous slope, a continuous magnitude and direction of a tangent vector throughout the curve 38, etc.

The width of the foil extension 36 is less than the width of the foil body 34. However, compared to the width of the foil extension 26 of FIG. 2A, the foil extension 36 of FIG. 2B may have a larger width relative to the width of the foil body 34, due to the larger curve 38 between the foil body 34 and the foil extension 36. For example, the portion of the foil extension 36 including the curve 38 may have a width that is, e.g., about eighty percent of a width of the foil body 34, thereby increasing the load bearing area of the portion where the foil extension 36 extends from the foil body 34.

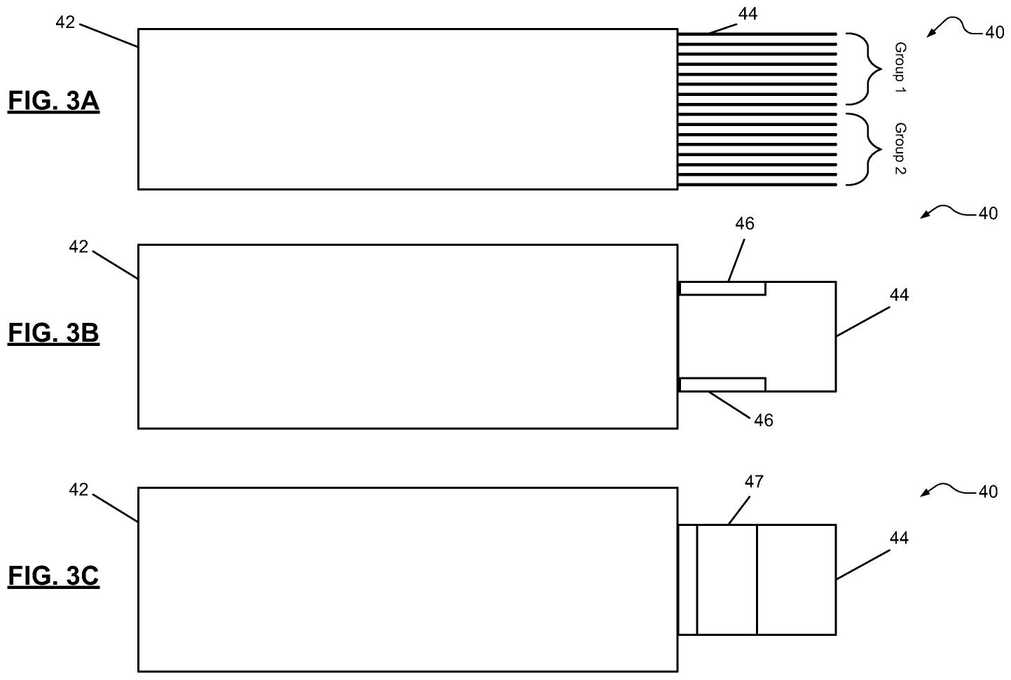

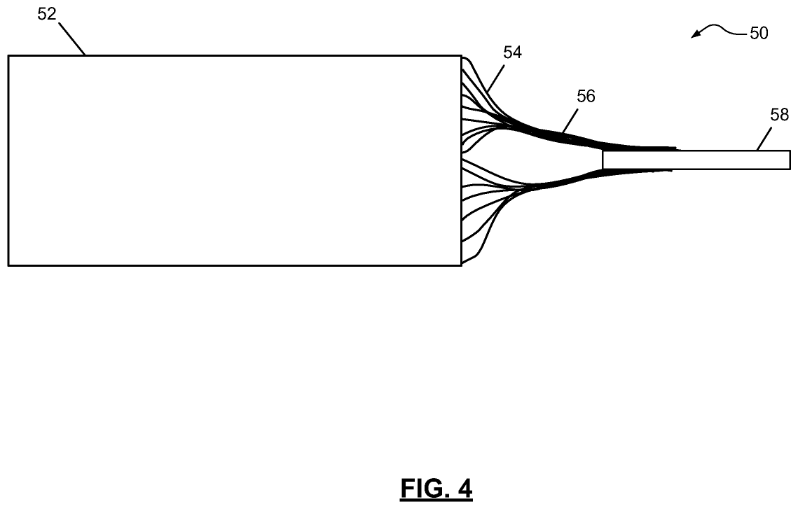

FIG. 3A is a side view of an example vehicle battery 40. The vehicle battery 40 includes a pouch cell 42 housing multiple electrode foils. Each electrode foil includes a foil extension 44 extending from the pouch cell 42. The foil extensions 44 are divided into two groups.

FIG. 3B is a top view of the vehicle battery 40 of FIG. 3B. As shown in FIG. 3B, two ultrasonic welds 46 have been performed along edges of the foil extensions 44. For example, all of the foil extensions 44 in the first group may be joined together via an ultrasonic weld 46 along one side edge of each of the foil extensions 44, and another ultrasonic weld 46 along another side edge of each of the foil extensions 44.

Ultrasonic welds may also be performed along side edges of the foil extensions 44 in the second group, to join the foil extensions 44 in the second group together along their side edges. Performing side edge welding of groups of foil extensions may provide increased strength at sides of the foil extensions, to help reduce or prevent cracking that might otherwise begin along a side edge of a foil extension 44.

Ultrasonic welding may be performed on areas of the foil extensions 44 other than side edges. For example, FIG. 3C is a top view of ultrasonic welds 47 over an area of each foil extension that extends across a middle portion of the foil extensions 44.

FIG. 4 is a side view illustrating an example of two groups of ultrasonic welded foil extensions coupled to outside portions of a lead tab. The vehicle battery 50 includes a pouch cell 52 having multiple electrode foils. Each electrode foil includes a foil extension 54 extending out of the pouch cell 52.

As shown in FIG. 4, a first group of the foil extensions 54 are grouped together via a first ultrasonic weld 56, and a second group of the foil extensions 54 are grouped together via a second ultrasonic weld 56. The vehicle battery 50 also includes a lead tab 58. For example, the lead tab 58 may be configured to connect the electrode foils of the pouch cell 52 to a power system of the vehicle.

The first and second ultrasonic welds 56 are coupled to outside surfaces of the lead tab 58. For example, the upper ultrasonic weld 56 is joined to an upper surface of the lead tab 58, and the lower ultrasonic weld 56 is joined to a lower surface of the lead tab 58.

In FIG. 4, the lead tab 58 is between the two ultrasonic welds 56 of the foil extensions 54. The two ultrasonic welds 56 of the foil extensions 54 may be joined to the lead tab 58 via, e.g., laser welding. Coupling the two ultrasonic welds 56 of the foil extensions 54 to the outer surfaces of the lead tab 58 may increase stability of the connection between the foil extensions 54 and the lead tab 58, and reduce the maximum stress on the foil extensions 54.

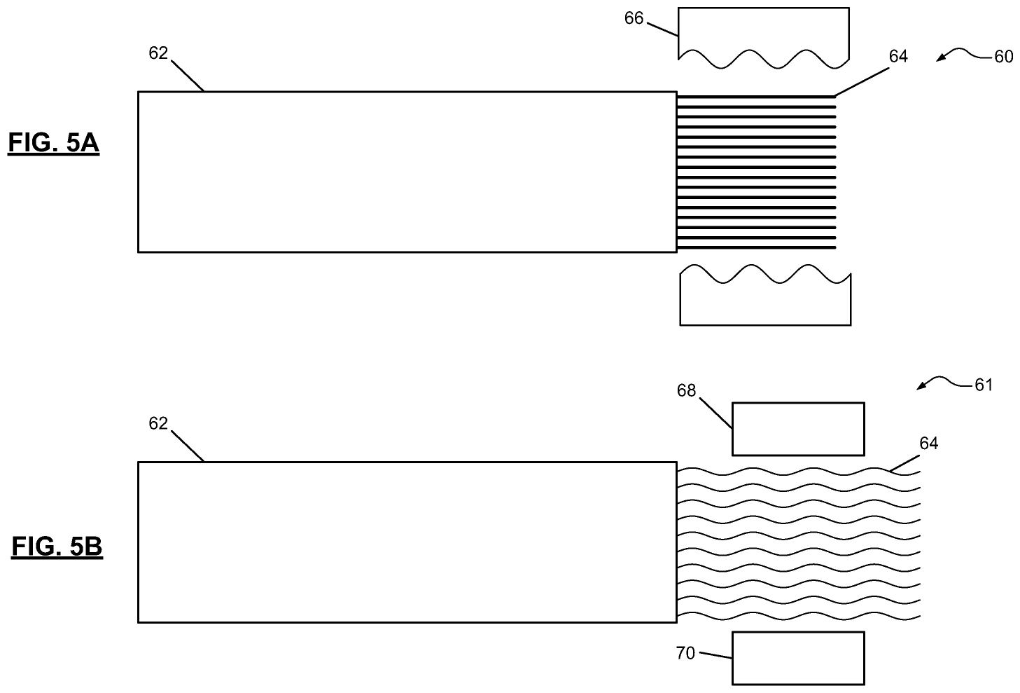

FIG. 5A is a side view illustrating an example apparatus 60 for pressing foil extensions to generate a wrinkle pattern. As shown in FIG. 5A, a pouch cell 62 includes multiple electrode foils, and each electrode foil includes a foil extension 64 extending out from the pouch cell 62.

A press 66 includes multiple hills and valleys, which define a wrinkle pattern having multiple wave oscillations. The press 66 may be pressed into the foil extensions 64, to form a wrinkle pattern in the foil extensions 64. For example, after being contacted by the press 66, surfaces of the foil extensions may include a wrinkle pattern having multiple wave oscillations, as shown in FIG. 5B.

FIG. 5B illustrates one example wrinkle pattern for the foil extensions 64, although other embodiments may include wrinkle patterns with smaller or larger amplitudes, smaller or larger wavelengths, wrinkle patterns that are non-periodic, wrinkle patterns that do not have curved oscillations, etc.

As shown in FIG. 5B, wrinkled foil extensions 64 may be joined via, e.g., an ultrasonic welding apparatus including an anvil 70 and a horn 68. For example, an ultrasonic process may be used to ultrasonically weld the foil extensions 64 having the wrinkle pattern in their surfaces. Adding a wrinkle pattern to the foil extensions 64 may reduce the likelihood of cracking of the foil extensions 64 after they are coupled to a lead tab, by reducing stress and tension in the foil extensions 64, etc.

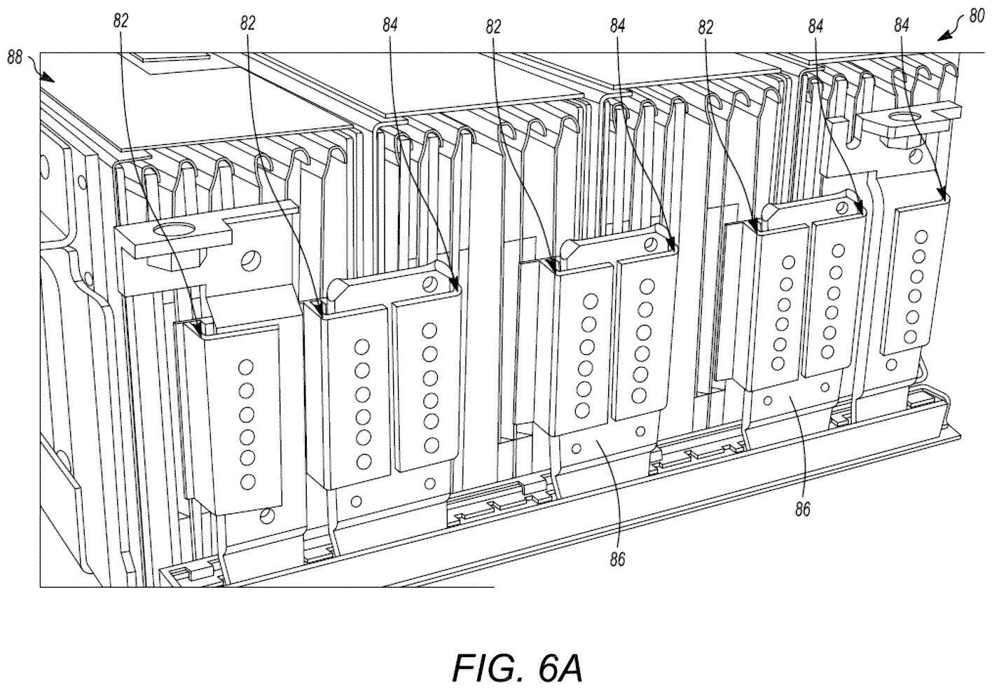

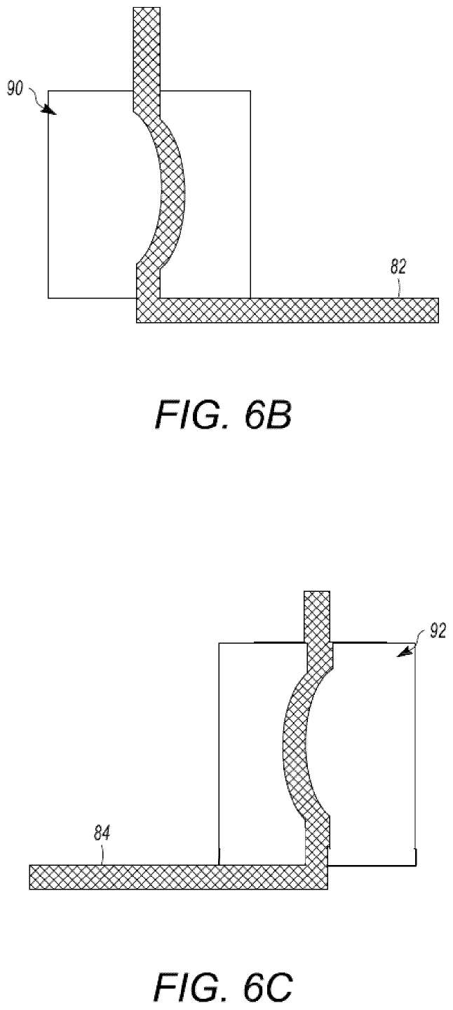

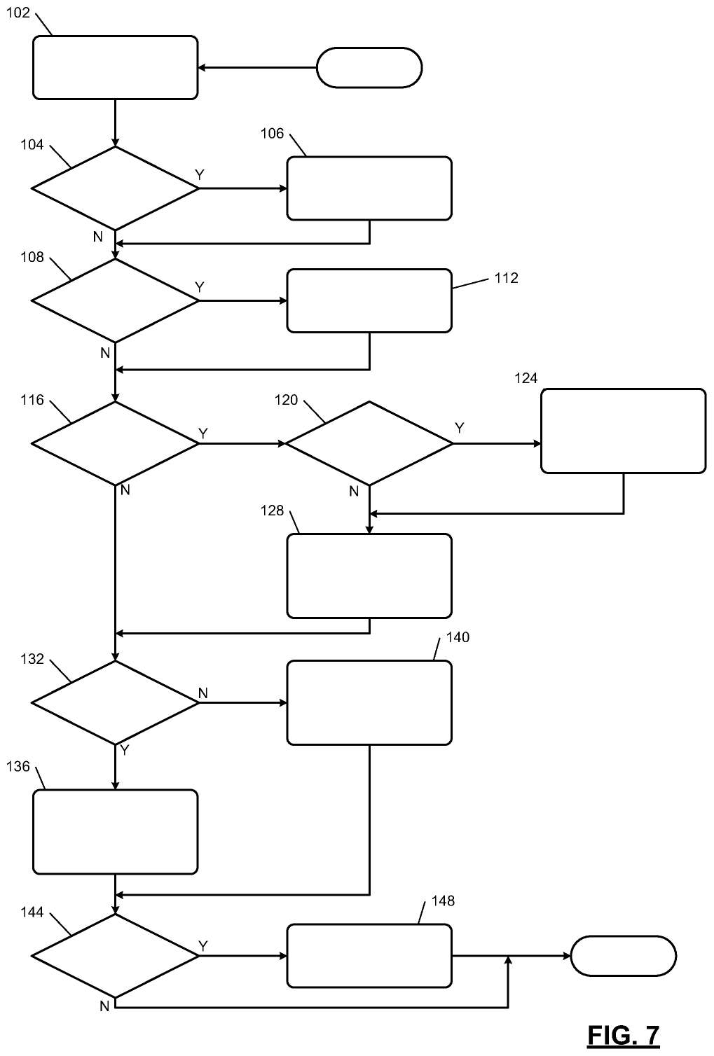

FIG. 6A is an orthogonal view illustrating an example of lead tabs welded to bus bars. The lead tabs may be curled around curved surfaces before being bent over to the bus bars for welding. Although FIG. 6A does not illustrate the clamps explicitly, examples of clamps having curved surfaces, and lead tabs curled around the clamps prior to being bent over to a bus bar for welding, are illustrated in FIGS. 6B and 6C.

As shown in FIG. 6A, a vehicle battery 80 includes multiple pouch cells 88. Each pouch cell 88 includes multiple electrode foils having multiple foil extensions. Each lead tab 82 may be a lead tab of, e.g., multiple joined foil extensions of a pouch cell 88. The bus bars 86 may be connected to a power system of a vehicle, such as a power system for driving an electric motor of an electric vehicle.

The lead tab 82 may be bent, curled, etc., around a curved surface of the clamp, prior to bending the lead tab 82 for mating the lead tab 82 to the bus bar 86. For example, the lead tab 82 may be curled inward (e.g., concave) in the middle section of the lead tab 82 just before the end section of the lead tab 82 that is bent and joined to the bus bar 86. The lead tab 82 may then be welded to the bus bar 86, while the middle section of the lead tab 82 is curled around the curved surface of the clamp. Although the clamps are not illustrated explicitly in FIG. 6A, FIGS. 6B and 6C illustrate examples of clamps having curved surfaces for curling a portion of the lead tabs 82 and 84. The clamps of FIGS. 6B and 6C may be implemented in the apparatus of FIG. 6A, for example, by clamping a portion of the lead tabs 82 and 84 that is between the bus bars 86 and the pouch cells 88.

After welding the lead tab 82 to the bus bar 86 (such as via laser welding), the clamp may be removed (e.g., by sliding the clamp out from between the lead tab 82 and the bus bar 86). Once the clamp is removed, slack may be generated in the foil extensions, such that the foil extensions experience less stress and tension, and are less likely to crack.

As shown in FIG. 6A, clamps may be used which have different orientations. For example, clamps having curved surfaces with a first orientation may be used to curl the lead tabs 82 in a first direction, and clamps having a different orientation (such as curved surfaces with a 180 degree opposite orientation) may be used to curl the lead tabs 84 in a second direction (which may be opposite to the curl direction of the lead tabs 82). Each clamp may have any suitable shape, such as a curve, an S-shape, etc., and a length of the curved surface of the clamp may be specified based on how much slack is desired to be added to the foil extensions after the clamps are removed.

FIG. 6B is a top view of an example lead tab curled around a curved surface of a clamp. For example, a lead tab 82 of FIG. 6A may be curled around a curved surface of the clamp 90, prior to bending the lead tab 82 over to a bus bar 86 for welding. As shown in FIG. 6B, the curved surface of the clamp 90 produces a curl in the lead tab 82, such that once the clamp 90 is removed after welding the lead tab 82 to the bus bar 86, the lead tab 82 will include some slack to reduce the strain on the tab and foil extensions welded to the lead tab.

FIG. 6C is a top view of another example lead tab curled around a curved surface of a clamp. For example, a lead tab 84 of FIG. 6A may be curled around a curved surface of the clamp 92, prior to bending the lead tab 84 over to a bus bar 86 for welding. The curved surface of the clamp 92 may be oriented in a different (e.g., opposite) direction to the clamp 90, in order to introduce a curl of a different direction in the lead tab 84. The orientation of the curved surface of the clamp 92 may depend on a direction in which the lead tab 84 is bent to reach to the bus bar 86 for welding. Although FIGS. 6B and 6C illustrate two examples of curved surfaces of the clamps, in other embodiments the clamps may include any suitable curved portion shapes to curl portions of the lead tabs.

FIG. 7 is a flowchart depicting an example process for manufacturing a vehicle battery including performing ultrasonic welding on foil extensions. The process may be performed by, e.g., a controller configured to execute computer-executable instructions to implement steps of the process illustrated in FIG. 7.

At 102, the controller is configured to initiate obtaining foil extensions of electrode foils. For example, multiple electrode foils may be stacked at least partially within a pouch cell of a vehicle battery, and the controller may be configured to identify a location of foil extensions of the multiple electrode foils.

At 104, the controller is configured to determine whether any foil extension subgroups have been specified. If so, the controller proceeds to 106 to identify subgroups of the foil extensions for welding (e.g., ultrasonic welding), prior to the lead tab weld. For example, if foil extension subgroups have been specified for the manufacturing process, the foil extensions within each subgroup may need to be ultrasonically welded together before they are laser welded to the lead tab.

The controller is configured to determine whether a wrinkle pattern is specified at 108. For example, the controller may check a stored manufacturing process specification to determine whether the foil extensions should be pressed with a wrinkle pattern prior to welding the foil extensions.

If the controller determines at 108 that a wrinkle pattern is specified, the controller is configured to proceed to 112 to press the foil extensions to create the wrinkle pattern in the foil extensions. For example, a press having multiple hills and valleys may be pressed into the foil extensions to create a wrinkle pattern in the foil extensions.

The wrinkle pattern may include multiple wave oscillations of a surface of the foil extensions. As another example, a wrinkle pattern may be created in the foil extensions using an apparatus having a horn and an anvil, such as an ultrasonic process to create the wrinkle pattern in the foil extensions. Examples of forming wrinkle patterns in foil extensions are illustrated in FIGS. 5A and 5B, and discussed further above.

After creating the wrinkle pattern at 112, or determining at 108 that a wrinklie pattern has not been specified, the controller is configured to proceed to 116 to determine whether ultrasonic welding has been specified. If so, the controller proceeds to 120 to determine whether edge welding has been specified.

For example, ultrasonic welding may be performed at various locations on the foil extensions. If the controller determines at 120 that edge welding has been specified, the controller is configured to proceed to 124 to perform ultrasonic welding on side edges of a group of foil extensions, to join the side edges of the group of foil extensions. The side edge welding may be performed for multiple foil extensions groups, for multiple side edges of each of the foil extensions, etc. Examples of side edge welding are illustrated in FIGS. 3A and 3B, and discussed further above.

After performing ultrasonic welding on the edges at 124, or determining at 120 that edge welding has not been specified, the controller is configured to proceed to 128 to perform ultrasonic welding at main overlapping areas of the groups of foil extensions. For example, groups of foil extensions may be ultrasonically welded prior to welding to a lead tab, in order to increase the strength of connection of the foil tabs and reduce tensions and stress in the foil extension. Examples of performing ultrasonic welding at main overlapping areas of foil extensions are illustrated in FIGS. 2A and 2B, and discussed further above.

The controller is configured to determine at 132 whether an outside tab weld has been specified. If so, the controller laser welds groups of foil extensions to outside portions of the tab at 136. For example, a first portion of foil extensions may be laser welded to a first outer surface of the lead tab, and a second portion of foil extensions may be laser welded to a second outer surface of the lead tab opposite to the first outer surface.

If the controller determines at 132 that an outside tab weld is not specified, the controller may be configured to laser weld groups of foil extensions on one side of the lead tab at 140. For example, the lead tab may overlap with the foil extensions (e.g., by putting the foil extensions on top of the portion of the lead tab, and the lead tab may be laser welded with the foil extensions.

At 144, the controller is configured to determine whether a clamp has been specified. If so, the controller is configured to initiate curling a lead tab around a curved surface of the clamp at 148, prior to welding the lead tab to the bus bar. This may create a bend in the lead tab, such that after welding the lead tab to the bus bar, the clamp may be removed, creating slack in the foil extensions to reduce tension and stress. Examples of using clamps prior to welding the lead tabs to the bus bars are illustrated in FIGS. 6A-C, and discussed further above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle battery comprising:
a pouch cell configured to provide power to at least one power system of a vehicle; and
multiple electrode foils stacked together at least partially within the pouch cell, wherein:
each of the multiple electrode foils includes a foil extension at an end of the electrode foil;
a first group of foil extensions are connected together via a first ultrasonic weld to define a first foil extension weld portion; and
a second group of foil extensions are connected together via a second ultrasonic weld to define a second foil extension weld portion.

2. The vehicle battery of claim 1, wherein the first foil extension weld portion and the second foil extension weld portion are connected together via a third ultrasonic weld.

3. The vehicle battery of claim 1, wherein:
each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge; and
the first ultrasonic weld includes an ultrasonic weld along at least one of the first side edge or the second side edge of each foil extension in the first group of foil extensions.

4. The vehicle battery of claim 1, further comprising a lead tab configured to electrically connect the electrode foils with the at least one power system of the vehicle,
wherein the first group of foil extensions and the second group of foil extensions are connected to the lead tab via a fusion weld.

5. The vehicle battery of claim 4, wherein:
the lead tab includes a first outer surface, and a second outer surface opposite to the first outer surface;
the first foil extension weld portion is connected to the first outer surface of the lead tab via a fusion weld; and
the second foil extension is connected to the second outer surface of the lead tab via a fusion weld.

6. The vehicle battery of claim 4, wherein at least a portion of the first foil extension and at least a portion of the second foil extension extend into the lead tab.

7. The vehicle battery of claim 4, further comprising at least one clamp including a curve portion, wherein the lead tab is bent around the curve portion of the at least one clamp.

8. The vehicle battery of claim 1, wherein a surface of each foil extension defines a wrinkle pattern having multiple wave oscillations.

9. The vehicle battery of claim 1, wherein, for each of the multiple electrode foils:
a width of the foil extension of the electrode foil is less than a width of a body of the electrode foil;
a curve is defied between an edge of the foil extension and an edge of the body of the electrode foil; and
the curve is a C1-continuity curve.

10. The vehicle battery of claim 1, wherein the multiple electrode foils include at least twenty electrode foils stacked together at least partially within the pouch cell.

11. A method of manufacturing a vehicle battery, the method comprising:
stacking multiple electrode foils together, each electrode foil configured to operate as a current collector of a vehicle battery;
inserting a stack of the multiple electrode foils at least partially within a pouch cell, each of the multiple electrode foils including a foil extension at an end of the electrode foil;
pressing the foil extensions to define a wrinkle pattern in each foil extension, the wrinkle pattern including multiple wave oscillations of a surface of the foil extension;
performing a first ultrasonic weld on a first group of foil extensions to define a first foil extension weld portion; and
performing a second ultrasonic weld on a second group of foil extensions to define a second foil extension weld portion.

12. The method of claim 11, further comprising performing a third ultrasonic weld to connect the first foil extension weld portion with the second foil extension weld portion.

13. The method of claim 11, wherein:
each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge; and
performing the first ultrasonic weld includes performing an ultrasonic weld along at least one of the first side edge or the second side edge of each foil extension in the first group of foil extensions.

14. The method of claim 11, further comprising performing a fusion weld to connect the first group of foil extensions and the second group of foil extensions to a lead tab,
wherein the lead tab is configured to electrically connect the electrode foils with at least one power system of a vehicle.

15. The method of claim 14, wherein:
the lead tab includes a first outer surface, and a second outer surface opposite to the first outer surface;
the first foil extension weld portion is connected to the first outer surface of the lead tab via laser weld; and
the second foil extension is connected to the second outer surface of the lead tab via laser weld.

16. A method of manufacturing a vehicle battery, the method comprising:
stacking multiple electrode foils together, each electrode foil configured to operate as a current collector of a vehicle battery;
inserting a stack of the multiple electrode foils at least partially within a pouch cell, each of the multiple electrode foils including a foil extension at an end of the electrode foil;
curling a portion of a lead tab around a curved surface of a clamp, the lead tab configured to electrically connect the electrode foils with at least one power system of a vehicle via the bus bar;
fusion welding the lead tab to the bus bar while the lead tab is curled around at least a portion of the clamp; and
removing the clamp after fusion welding the lead tab to the bus bar, to relieve tension in the foil extensions.

17. The method of claim 16, further comprising, prior to fusion welding the lead tab to the bus bar:
performing a first ultrasonic weld on a first group of foil extensions to define a first foil extension weld portion; and
performing a second ultrasonic weld on a second group of foil extensions to define a second foil extension weld portion.

18. The method of claim 17, further comprising performing a third ultrasonic weld to connect the first foil extension weld portion with the second foil extension weld portion.

19. The method of claim 17, wherein:
each foil extension includes a first end integral with a body of the one of the multiple electrode foils from which the foil extension extends, a second end opposite to the first end, a first side edge between the first end and the second end, and a second side edge between the first end and the second end, the first side edge opposite to the second side edge; and
performing the first ultrasonic weld includes performing an ultrasonic weld along at least one of the first side edge or the second side edge of each foil extension in the first group of foil extensions.

20. The method of claim 17, further comprising, prior to performing the first ultrasonic weld and the second ultrasonic weld, pressing the foil extensions to define a wrinkle pattern in each foil extension, the wrinkle pattern including multiple wave oscillations of a surface of the foil extension.
